(19) United States
(12) Patent Application Publication
(10) Pub. No.: US 2012/0058272 A1
(43) Pub. Date: Mar. 8, 2012

(54) TRANSPARENT INK-JET RECORDING FILMS, COMPOSITIONS, AND METHODS

(76) Inventors: Sharon M. Simpson, Lake Elmo, MN (US); James L. Johnston, Brighton, CO (US); James R. Wagner, Stillwater, MN (US); William D. Devine, Fort Collins, CO (US); William J. Ruzinsky, Loveland, CO (US)

(21) Appl. No.: 13/204,840

(22) Filed: Aug. 8, 2011

Related U.S. Application Data
(60) Provisional application No. 61/379,859, filed on Sep. 3, 2010.

(51) Int. Cl. C08K 3/28; B05D 5/00; B41M 5/00

(52) U.S. Cl. 427/256; 524/429; 428/32.1

(57) ABSTRACT

Transparent ink-jet recording films, compositions, and methods are disclosed. These films exhibit high maximum optical densities and have low haze values. These films are useful for medical imaging.

### CROSS REFERENCE TO RELATED APPLICATIONS

This application claims the benefit of U.S. Provisional Application No. 61/379,859, filed Sep. 3, 2010, which is hereby incorporated by reference in its entirety.

### BACKGROUND

Transparent ink-jet recording films typically employ one or more image-receiving layers on which ink is deposited during the ink-jet printing process. In some embodiments, such image-receiving layers may comprise polymeric binders and inorganic particles, such as, for example, boehmite alumina. In order to obtain high image densities when printing on transparent films, more ink is often applied during the ink-jet printing process than is required for opaque films. To be able to accommodate more printing ink, image-receiving layer thicknesses can be increased relative to those in opaque films. However, such a change generally increases the amount of water or organic solvents that must be removed from the wet image-receiving layers during the film drying portion of the manufacturing process. Moving to more aggressive drying conditions to compensate can cause undesirable patterns to form on the film; however, use of mild drying conditions can adversely impact process throughput. Unfortunately, moving to higher solids coating mixes to reduce the amount of liquid to be removed by drying can entail handling high viscosity slurries with the risk of gelation during process upsets.

U.S. Pat. No. 4,186,178 to Oberlander, which is hereby incorporated by reference in its entirety, discloses that increasing alumina concentration in dispersions increases their tendency to gel. Treatment of dispersions with acid can improve dispersibility, but use of excessive acid can cause gelation. Oberlander discloses treating alumina with hot water and acidifying to improve dispersion stability. Dispersions with pHs from 4.06 to 4.36 are disclosed.

U.S. Pat. No. 4,676,928 to Leach et al., which is hereby incorporated by reference in its entirety, discloses alumina dispersions with pH from about 2 to about 4. However, Leach et al. maintain that such low pH dispersions are corrosive and that the properties of such low pH dispersions can be variable because of their sensitivity to the presence of impurities. Leach et al. disclose adding sufficient acid to alumina slurries of pH greater than 9 to lower their pH to about 5, heating to form a colloidal sol with pH greater than about 4, and recovering water-dispersible alumina from the sol.

A Sasol technical bulletin, DISPERAL®/DISPAL® High Purity Dispersible Aluminas, 2003, and a Sasol technical presentation, Inorganic Specialty Chemicals, 2005, each of which is hereby incorporated by reference in its entirety, disclose that alumina dispersions flocculate at pHs near 7 and that dispersion viscosities exhibit two minima at pHs of about 4 and about 10. Dispersion viscosities are shown to increase over several orders of magnitude as pH decreases below about 4. The presentation indicates that use of dispersion pHs below 2 may cause gelation. The presentation also discloses adding alumina to deionized water, acidifying, heating to 80° C. with stirring, separating non-dispersed particles, optionally adding acid to control pH, adding a binder, and either avoiding gel-promoting cationic additives or adding them just prior to coating.

### SUMMARY

Transparent ink-jet recording films often employ one or more image-receiving layers on one or both sides of a transparent support. In order to obtain high image densities when printing on transparent films, more ink is often applied than is required for opaque films. To be able to accommodate more printing ink, image-receiving layer thicknesses can be increased relative to those in opaque films. The compositions and methods of the present application can provide transparent ink-jet recording films with increased image-receiving layer thicknesses. Such films can exhibit high maximum optical densities and low haze values.

One embodiment provides a method comprising providing a first composition comprising alumina, nitric acid, and water, with the first composition comprising at least about 25 wt % alumina and having a pH below about 3.09; forming an alumina mix according to a method comprising heating the first composition; and forming an image-receiving layer from a second composition comprising said alumina mix and at least one first water soluble or water dispersible polymer. The alumina may, in some cases, comprise boehmite alumina. The at least one first water soluble or water dispersible polymer may comprise, for example, poly(vinyl alcohol). In some embodiments, the first composition may comprise at least about 30 wt % alumina. In some embodiments, the pH may be below about 2.73, or may be, for example, between about 2.17 and about 2.73. In some embodiments, the alumina mix may comprise at least about 25 wt % solids or at least about 30 wt % solids. In some cases, heating the first composition may comprise heating the first composition to at least about 80° C.

In some embodiments, the method further comprises forming an under-layer from a third composition, which comprises gelatin and a borate or borate derivative, such as, for example, borax. The third composition may, for example, comprise at least about 4 wt % solids, or at least about 9.2 wt % solids, or at least about 15 wt % solids. In at least some embodiments, the ratio of the borate or borate derivative to the gelatin may be, for example, between about 20:80 and about 50:50 by weight, or the ratio may be about 0.45:1 by weight.

Another embodiment provides a transparent ink jet recording film comprising the ink-jet image-receiving layer formed according to these or other embodiments. Such image-receiving layers may have dry coating weights of, for example, at least about 40 g/m² on a dry basis, or at least about 41.0 g/m² on a dry basis, or at least about 41.3 g/m² on a dry basis, or at least about 45 g/m² on a dry basis, or at least about 49 g/m² on a dry basis. Such ink-jet recording films may further comprise an under-layer formed from a third composition, which comprises gelatin and a borate or borate derivative, such as, for example, borax. Such an under-layer may, for example, comprise at least about 2.9 g/m² on a dry basis, or at least about 4.0 g/m² on a dry basis, or at least about 4.2 g/m² on a dry basis, or at least about 5.0 g/m² on a dry basis, or at least about 5.8 g/m² on a dry basis. Such ink-jet recording films may have optical densities of, for example, at least about 2.8. Such films may have haze values of, for example, below about 24, or below about 23, or below about 19, or below about 16.

Also provided are methods comprising printing on the transparent ink-jet recording film according to these or other embodiments.

These embodiments and other variations and modifications may be better understood from the detailed description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DETAILED DESCRIPTION

All publications, patents, and patent documents referred to in this document are incorporated by reference herein in their entirety, as though individually incorporated by reference.

U.S. Provisional Application No. 61/379,859, filed Sep. 3, 2010, is hereby incorporated by reference in its entirety.

### Introduction

An ink-jet recording film may comprise at least one image-receiving layer, which receives ink from an ink-jet printer during printing, and a substrate or support, which may be opaque or transparent. An opaque support may be used in films that may be viewed using light reflected by a reflective backing, while a transparent support may be used in films that may be viewed using light transmitted through the film.

Some medical imaging applications require high image densities. For a reflective film, high image densities may be achieved by virtue of the light being absorbed on both its path into the imaged film and again on the light's path back out of the imaged film from the reflective backing. On the other hand, for a transparent film, because of the lack of a reflective backing, achievement of high image densities may require application of larger quantities of ink than are common for opaque films. In such cases, larger quantities of liquids must generally be removed while drying transparent films during their manufacture, which can impact the both the quality of the dried film and the throughput of the drying process.

### Transparent Ink-Jet Films

Transparent ink-jet recording films are known in the art. See, for example, U.S. patent application Ser. No. 13/176,788, “TRANSPARENT INK-JET RECORDING FILM,” by Simpson et al., filed Jul. 6, 2011, and U.S. Provisional Patent Application No. 61/375,325, “SMUDGE RESISTANCE OF MATTE BLANK INKS AND DRYING OF INKS USING A 2-LAYER INKJET RECEPTOR CONTAINING A MONOSACCHARIDE OR DISACCHARIDE ON A TRANSPARENT SUPPORT,” by Simpson et al., filed Aug. 20, 2010, both of which are hereby incorporated by reference in their entirety.

Transparent ink jet recording films may comprise one or more transparent substrates upon which at least one under-layer may be coated. Such an under-layer may optionally be dried before being further processed. The film may further comprise one or more image-receiving layers coated upon at least one under-layer. Such an image-receiving layer is generally dried after coating. The film may optionally further comprise additional layers, such as one or more primer layers, subbing layers, backing layers, or overcoat layers, as will be understood by those skilled in the art.

### Under-Layer Coating Mix

Under-layers may be formed by applying at least one under-layer coating mix to one or more transparent substrates. The under-layer formed may, in some cases, comprise at least about 2.9 g/m² solids on a dry basis, or at least about 3.0 g/m² solids on a dry basis, or at least about 3.5 g/m² solids on a dry basis, or at least about 4.0 g/m² solids on a dry basis, or at least about 4.2 g/m² solids on a dry basis, or at least about 5.0 g/m² on a dry basis, or at least about 5.8 g/m² on a dry basis. The under-layer coating mix may comprise gelatin. In at least some embodiments, the gelatin may be a Regular Type IV bovine gelatin. The under-layer coating mix may further comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the under-layer coating mix. In some embodiments, the borate or borate derivative may be used in an amount of up to, for example, about 2 g/m². In at least some embodiments, the ratio of the at least one borate or borate derivative to the gelatin may be between about 20:80 and about 1:1 by weight, or the ratio may be about 0.45:1 by weight. In some embodiments, the under-layer coating mix may comprise, for example, at least about 4 wt % solids, or at least about 9.2 wt % solids. The under-layer coating mix may comprise, for example, about 15 wt % solids.

The under-layer coating mix may also optionally comprise other components, such as surfactants, such as, for example, nonyl phenol, glycidyl polyether. In some embodiments, such a surfactant may be used in amount from about 0.001 to about 0.20 g/m², as measured in the under-layer. In some embodiments, the under-layer coating mix may optionally further comprise a thickener, such as, for example, a sulfonated polystyrene. These and other optional mix components will be understood by those skilled in the art.

### Image-Receiving Layer Coating Mix

Image-receiving layers may be formed by applying at least one image-receiving layer coating mix to one or more under-layer coatings. The image-receiving layer formed may, in some cases, comprise at least about 40 g/m² solids on a dry basis, or at least about 41.0 g/m² solids on a dry basis, or at least about 41.3 g/m² solids on a dry basis, or at least about 45 g/m² on a dry basis, or at least about 49 g/m² on a dry basis. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the at least one water soluble or water dispersible polymer may be used in an amount of up to about 1.0 to about 4.5 g/m², as measured in the image-receiving layer.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or between about 90:10 and about 95:5 by weight, or the ratio may be about 92:8 by weight.

Image-receiving layer coating layer mixes prepared from alumina mixes with higher solids fractions can perform well in this application. However, high solids alumina mixes can, in general, become too viscous to be processed. It has been discovered that suitable alumina mixes can be prepared at, for example, 25 wt % or 30 wt % solids, where such mixes comprise alumina, nitric acid, and water, and where such mixes comprise a pH below about 3.09, or below about 2.73, or between about 2.17 and about 2.73. During preparation, such alumina mixes may optionally be heated, for example, to 80° C.

The image-receiving coating layer mix may also comprise one or more surfactants such as, for example, nonyl phenol, glycidyl polyether. In some embodiments, such a surfactant may be used in amount of, for example, about 1.5 g/m², as measured in the image-receiving layer. In some embodiments, the image-receiving coating layer may also optionally comprise one or more acids, such as, for example, nitric acid.

These and other components may optionally be included in the image-receiving coating layer mix, as will be understood by those skilled in the art.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may optionally be included in the transparent substrate, as will be understood by those skilled in the art.

In some embodiments, the transparent substrate may be provided as a continuous or semi-continuous web, which travels past the various coating, drying, and cutting stations in a continuous or semi-continuous process.

### Coating

The at least one under-layer and at least one image-receiving layer may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using such methods as, for example, slide coating.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com).

### Drying

Coated layers, such as, for example under-layers or image-receiving layers, may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com). In some embodiments, coating layers may be dried as they travel past one or more perforated plates through which a gas, such as, for example, air or nitrogen, passes. Such an impingement air dryer is described in U.S. Pat. No. 4,365,423 to Arter et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water may be limited by its dew point, while its ability to remove organic solvents may be limited by the amount of such solvents in the gas, as will be understood by those skilled in the art.

In some embodiments, the under-layer may be dried by exposure to ambient air. Image-receiving layers may be dried by exposure to air at, for example, 85° C. for 10 min in a Blue M Oven.

### Exemplary Embodiments

U.S. Provisional Application No. 61/379,859, filed Sep. 3, 2010, which is hereby incorporated by reference in its entirety, disclosed the following twelve non-limiting exemplary embodiments:

A. A method comprising:

providing a first composition comprising alumina, nitric acid, and water, said first composition comprising at least about 25 wt % alumina and comprising a pH below about 3.09;

forming an alumina mix according to a method comprising heating the first composition; and

forming an image-receiving layer from a second composition comprising said alumina mix and at least one first water soluble or water dispersible polymer.

B. The method according to embodiment A, further comprising forming an under-layer from a third composition comprising gelatin and a borate or borate derivative.
C. The method according to embodiment A, wherein said at least one first water soluble or water dispersible polymer comprises poly(vinyl alcohol).
D. The method according to embodiment A, wherein said first composition comprises at least about 30 wt % alumina.
E. The method according to embodiment A, wherein said pH is below about 2.73.
F. The method according to embodiment A, wherein said pH is between about 2.17 and about 2.73.
G. The method according to embodiment A, wherein the alumina mix comprises at least about 25 wt % solids.
H. The method according to embodiment A, wherein the alumina mix comprises at least about 30 wt % solids.
I. The method according to embodiment A, wherein said heating the first composition comprises heating the first mixture to about 80° C.
J. A transparent ink-jet recording film comprising the image-receiving layer formed according to the method of embodiment A.
K. The transparent ink-jet recording film of embodiment J, further comprising an under-layer formed from a third composition comprising gelatin and a borate or borate derivative.
L. A method comprising printing on the transparent ink-jet recording film according to embodiment J.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 140 nm. It is available from Sasol North America, Inc., Houston, Tex.

Gelatin is a Regular Type IV bovine gelatin. It is available as Catalog No. 8256786 from Eastman Gelatine Corporation, Peabody, Mass.

KATHON® LX is a microbiocide. It is available from Dow Chemical.

Surfactant 10G is an aqueous solution of nonyl phenol, glycidyl polyether. It is available from Dixie Chemical Co., Houston, Tex.

VERSA-TO 502 is a sulfonated polystyrene (1,000,000 molecular weight). It is available from AkzoNobel.

### Methods for Examples 1-4

Coated films were imaged with an EPSON® 7900 ink-jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8.

Immediately after the film exited the printer, the ink-jet image was turned over and placed over a piece of white paper. The percent of wet ink on the step having the maximum density (“wetness value”) was graded on a scale of 0 (completely dry) to 100 (completely wet).

The optical density of each coated film was measured using a calibrated X-RITE® Model DTP 41 Spectrophotometer (X-Rite, Inc., Grandville, Mich.) in transmission mode.

Haze (%) was measured in accord with ASTM D 1003 by conventional means using a HAZE-GARD PLUS Hazemeter, available from BYK-Gardner (Columbia, Md.).

### Example 1

### Comparative

A nominal 20 wt % alumina mix was prepared at room temperature by mixing 4.62 g of a 22 wt % aqueous solution of nitric acid and 555.38 g of deionized water. To this mix, 140 g of alumina powder (DISPERAL® HP-14) was added over 30 min. The pH of the mix was adjusted to 3.25 by adding nitric acid solution. The mix was heated to 80° C. and stirred for 30 min. The mix was cooled to room temperature and held for gas bubble disengagement prior to use.

### Example 2

### Comparative

A nominal 25 wt % alumina mix was prepared at room temperature by mixing 5.78 g of a 22 wt % aqueous solution of nitric acid and 519.22 g of deionized water. To this mix, 175 g of alumina powder (DISPERAL® HP-14) was added over 30 min. The pH of the mix was 3.09. The mix was heated to 80° C. and stirred for 30 min. The mix was cooled to room temperature and held for gas bubble disengagement prior to use. The mix was characterized as being very viscous and unsuitable for use in knife-coating.

### Example 3

A nominal 25 wt % alumina mix was prepared at room temperature by mixing 9.01 g of a 22 wt % aqueous solution of nitric acid and 515.99 g of deionized water. To this mix, 175 g of alumina powder (DISPERAL® HP-14) was added over 30 min. The pH of the mix was 2.73. The mix was heated to 80° C. and stirred for 30 min. The mix was cooled to room temperature and held for gas bubble disengagement prior to use. This mix was much less viscous than the alumina mix of Example 2.

### Example 4

A nominal 30 wt % alumina mix was prepared at room temperature by mixing 310 g of a 22 wt % aqueous solution of nitric acid and 7740 g of deionized water. To this mix, 3450 g of alumina powder (DISPERAL® HP-14) was added over 30 min. The pH of the mix was adjusted to 2.17 by adding an additional 15 g of the nitric acid solution. The mix was heated to 80° C. and stirred for 30 min. The mix was cooled to room temperature and held for gas bubble disengagement prior to use. The cooled mix had a pH of 2.73.

A nominal 26 wt % image-receiving coating mix was prepared at room temperature by introducing 2801 g of a 10 wt % aqueous solution of poly(vinyl alcohol) (CELVOL® 540) into a mixing vessel and agitating. To this mix, 10739 g of the 30 wt % alumina mix and 259 g of a 10 wt % aqueous solution of nonyl phenol, glycidyl polyether (Surfactant 10G) was added. The mix was cooled to room temperature and held for gas bubble disengagement prior to use. This mix had a viscosity of 83.5 cP at 40° C.

A nominal 9.2 wt under-layer coating mix was prepared at room temperature by introducing 4793 g of deionized water to a mixing vessel. 360 g of gelatin was added to the agitated vessel and allowed to swell. This mix was heated to 60° C. and held until the gelatin was fully dissolved. The mix was then cooled to 50° C. To this mix, 162 g of borax (sodium tetraborate decahydrate) was added and mixed until the borax was fully dissolved. To this mix, 562 g of an aqueous solution of 3.2 wt % sulfonated polystyrene (VERSA-TO 502, AkzoNobel) and 0.2 wt % microbiocide (KATHON® LX, Dow) was added and mixed until homogeneous. The mix was then cooled to 40° C. 123 g of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The ratio of borax to gelatin in the resulting under-layer coating mix was 0.45:1 by weight. This mix had a viscosity of 64.3 cP at 40° C.

The under-layer coating mix was heated to 40° C. and applied continuously to room temperature blue-tinted polyethylene terephthalate webs, which were moving at a speed of 30.0 ft/min. Under-layer coating mix feed rates of 28.8 and 41.3 g/min were used to provide under-layer coating weights of 2.90 and 4.15 g/m², respectively. The coated webs were dried continuously by moving past perforated plates through which room temperature air flowed. The pressure drop across the perforated plates was 0.8 in H₂O. The air dew point ranged from 7 to 13° C.

The image-coating mix was heated to 40° C. and coated onto the under-layer coated surfaces of room temperature polyethylene terephthalate webs, which were moving at a speed of 30.0 ft/min. Image-receiving coating mix feed rates of 109.0 and 145.4 g/min were used. The coated films were dried continuously by moving past perforated plates through which room temperature air flowed. The pressure drop across the perforated plates was 0.8 in H₂O. The air dew point ranged from 7 to 13° C. Dried image-receiving layer coating weights ranged from 30.3 to 41.0 g/m².

Coated films were evaluated as described above. Results are summarized in Table I. Samples B and D exhibited better drying behavior than Samples A and C, with Sample D being the best. Optical densities ranged from 2.939 to 3.233. Haze values ranged from 16.6% to 18.4%.

TABLE I

| | Image- | Image- | Under- | | | | |
|---|---|---|---|---|---|---|---|
| | Receiving | Receiving | Layer | | | | |
| | Layer | Layer | Coating | Under- | | | |
| | Coating | Dry | Mix | Layer | | | |
| | Mix Flow | Coating | Flow | Coating | Max. | | |
| | Rate | Weight | Rate | Weight | Optical | Haze | |
| ID | (g/min) | (g/sq. m) | (g/min) | (g/sq. m) | Density | (%) | Wetness |
| A | 109.0 | 30.3 | 28.8 | 2.90 | 3.233 | 15.7 | Wedge 5 100% wet |
| B | 145.4 | 40.3 | 28.8 | 2.90 | 3.111 | 16.8 | Wedge 4 100% wet |
| C | 109.0 | 30.5 | 41.3 | 4.15 | 3.102 | 17.2 | Wedge 5 100% wet |
| D | 145.4 | 41.0 | 41.3 | 4.15 | 2.939 | 18.4 | Wedge 3 25% wet |

### Example 5

### Preparation of Under-Layer Coating Mix

To a mixing vessel, 998 parts by weight of demineralized water was introduced. 78 parts of gelatin was added to the agitated vessel and allowed to swell. This mix was heated to 60° C. The mix was then cooled to 46° C. To this mix, 35 parts of borax (sodium tetraborate decahydrate) was added and held for 15 min. To this mix, 120 parts of an aqueous solution of 32.5 wt % sulfonated polystyrene (VERSA-TL® 502, AkzoNobel) and 0.2 wt % microbiocide (KATHON® LX, Dow) was added and mixed until homogeneous. The mix was then cooled to 40° C. 26 parts of a 10 wt % aqueous solution of nonyl phenol, glycidyl polyether (Surfactant 10G) and 39 parts demineralized water were then added and mixed until homogeneous. This mix was cooled to room temperature and held to allow disengagement of any gas bubbles prior to use. The weight ratio of borax to gelatin in the resulting under-layer coating mix was 0.45:1.

### Preparation of Poly(Vinyl Alcohol) Mix

A poly(vinyl alcohol) mix was prepared at room temperature by adding 7 parts by weight of poly(vinyl alcohol) (CELVOL® 540) to a mixing vessel containing 93 parts of dimineralized water over 10 min with 500 rpm agitation. This mixture was heated to 85° C. and agitated for 30 minutes. The mixture was then allowed to cool to room temperature. Dimineralized water was added to make up for water lost due to evaporation.

### Preparation of Alumina Mix

An alumina mix was prepared at room temperature by mixing 75.4 parts by weight of a 9.7 wt % aqueous solution of nitric acid and 764.6 parts of demineralized water. To this mix, 360 parts of alumina powder (DISPERAL® HP-14) was added over 30 min. The mix was heated to 80° C. and stirred for 30 min. The mix was cooled to room temperature and held for gas bubble disengagement prior to use. The pH of the resulting alumina mix was 3.28.

### Preparation of Image-Receiving Layer Coating Mix

An image-receiving coating mix was prepared at room temperature by introducing 470 parts of the alumina mix into a mixing vessel and agitating. The mix was heated to 40° C. To this mix, 175 parts by weight of the 7 wt % aqueous solution of poly(vinyl alcohol) (CELVOL® 540) and 11 parts of a 10 wt % aqueous solution of nonyl phenol, glycidyl polyether (Surfactant 10G) were added. After 30 min, the resulting mixture was cooled to room temperature and held for gas bubble disengagement prior to use.

### Preparation of the Coated Film

The under-layer coating mix was applied to a continuously moving polyethylene terephthalate web. The coated web was dried continuously by moving past perforated plates through which room temperature air flowed. The pressure drop across the perforated plates was in the range of 0.2 to 5 in H₂O. The air dew point was in the range of −4 to 12° C. The under-layer dry coating weight was 5.4 g/m².

The image-receiving layer coating mix was applied to the under-layer coating and dried in a second pass. The coated film was dried continuously by moving past perforated plates through which room temperature air flowed. The pressure drop across the perforated plates was in the range of 0.2 to 5 in H₂O. The air dew point was in the range of −4 to 12° C. The image-receiving layer dry coating weight was 48.2 g/m².

No mud cracking or impingement patterning was seen in the coated film.

### Evaluation of Coated Film

Samples of the coated film were evaluated at three sets of temperatures and humidities after equilibrating at these conditions for at least 16 hrs prior to printing. The coated film samples were imaged with an EPSON® 4900 ink-jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8. as measured by a calibrated X-RITE® Model DTP 41 Spectrophotometer (X-Rite, Inc., Grandville, Mich.) in transmission mode. Immediately after each film sample exited the printer, the ink-jet image was turned over and placed over a piece of white paper. The fraction of each wedge that was wet was recorded by sequential wedge number, with wedge 1 being the wedge having the maximum optical density and wedge 17 being the wedge with the minimum optical density. In general, the higher number wedges dried before the lowest number wedges.

A measure of wetness was constructed by taking the largest wedge number for the set of completely wet wedges and adding to it the fractional wetness of the adjacent wedge with the next higher wedge number. For example, if wedges 1 and 2 were completely wet and wedge 3 was 25% wet, the wetness value would be 2.25. Or if no wedges were completely wet, but wedge 1 was 75% wet, the wetness value would be 0.75.

Table II summarizes the ink-drying results for the coated film samples. The coated film sample printed under the lowest humidity conditions attained a wetness score of 0; that printed under intermediate humidity conditions attained a wetness score of 0.125, and that printed under the highest humidity conditions attained a wetness score of 0.25-0.5.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE II

| | | Printing | Maximum | |
|---|---|---|---|---|
| | Printing | Relative | Optical | Wetness |
| ID | Temperature | Humidity | Density | Value |
| 2-1 | 20° C. | 86% | 2.887 | 0.25-0.50 |
| 2-2 | 24° C. | 47% | 2.845 | 0 |
| 2-3 | 30° C. | 73% | 2.932 | 0.125 |

1. A method comprising:
providing a first composition comprising alumina, nitric acid, and water, said first composition comprising at least about 25 wt % alumina and comprising a pH below about 3.09;
forming an alumina mix according to a method comprising heating the first composition; and
forming an image-receiving layer from a second composition comprising said alumina mix and at least one first water soluble or water dispersible polymer.

2. The method according to claim 1, further comprising forming an under-layer from a third composition comprising gelatin and a borate or borate derivative.

3. The method according to claim 1, wherein the alumina comprises boehmite alumina.

4. The method according to claim 1, wherein said at least one first water soluble or water dispersible polymer comprises poly(vinyl alcohol).

5. The method according to claim 1, wherein said first composition comprises at least about 30 wt % alumina.

6. The method according to claim 1, wherein said pH is below about 2.73.

7. The method according to claim 1, wherein said pH is between about 2.17 and about 2.73.

8. The method according to claim 1, wherein the alumina mix comprises at least about 25 wt % solids.

9. The method according to claim 1, wherein the alumina mix comprises at least about 30 wt % solids.

10. The method according to claim 1, wherein said heating the first composition comprises heating the first mixture to about 80° C.

11. A transparent ink jet recording film comprising the image-receiving layer formed according to the method of claim 1.

12. The transparent ink-jet recording film of claim 11, further comprising an under-layer formed from a third composition comprising gelatin and a borate or borate derivative.

13. A method comprising printing on the transparent ink-jet recording film according to claim 11.
